(19) United States
(12) Patent Application Publication
(10) Pub. No.: US 2026/0042417 A1
(43) Pub. Date: Feb. 12, 2026

(54) LOCKING MECHANISM FOR TRAILER LANDING LEG

(71) Applicant: Bizringer Inc., Costa Mesa, CA (US)

(72) Inventor: Ratan Baid, Newport Beach, CA (US)

(21) Appl. No.: 19/139,287

(22) PCT Filed: Feb. 13, 2025
(86) PCT No.: PCT/US25/15858

§ 371 Date: Jun. 13, 2025

Related U.S. Application Data
(60) Provisional application No. 63/553,086, filed on Feb. 13, 2024.

(51) Int. Cl. B60R 25/01; B60R 25/102; B60R 25/23; B60R 25/24; B60R 25/32; B60R 25/33; B60R 25/34; B60R 25/40; B60S 9/04

(52) U.S. Cl. CPC B60R 25/01; B60R 25/102; B60R 25/23; B60R 25/241; B60R 25/245; B60R 25/32; B60R 25/33; B60R 25/34; B60R 25/403; B60S 9/04; B60R 2325/105

(57) ABSTRACT

A locking mechanism for a trailer landing leg is described. The locking mechanism has a bracket, a crank shaft attachment, and a locking pin assembly. The bracket securely attaches over the crank shaft of the landing leg via one or more one-time fasteners. The locking pin assembly attaches to the bracket via one or more one-time fasteners. The crank shaft attachment attaches to the crank shaft and the handle via one or more one-time fasteners. The crank shaft attachment surrounds the crank shaft and the handle. The locking pin assembly has a locking pin that transitions between a locked position and an unlocked position. The locking pin prevents the crank shaft attachment from rotating when in the locked position. The locking pin assembly also has a processor, a GPS tracker, sensors, and a wireless communication device that can detect tampering and alert a user.

This application is a national stage entry of PCT/US25/15858, filed on Feb. 13, 2025, which claims priority to U.S. provisional application Ser. No. 63/553,086, filed on Feb. 13, 2024, which are incorporated by reference herein.

### FIELD OF THE INVENTION

The field of the invention is locks, more specifically, locking mechanisms for trailer landing legs.

### BACKGROUND

The following description includes information that may be useful in understanding the present invention. It is not an admission that any of the information provided herein is prior art or relevant to the presently claimed invention, or that any publication specifically or implicitly referenced is prior art.

A semi-trailer truck is a combination of trailer and a truck vehicle (also referred to as tractor). The semi-trailer is removably attached to the truck by a hitch. The semi-trailer has a rear axle with wheels but does not have a front axle. Instead, a semi-trailer has a pair of front legs called landing legs that are deployed (e.g., lowered) when the semi-trailer is detached from the truck and retracted (e.g., raised) when attached to the truck. Semi-trailer trucks are an essential element of commerce and are responsible for distributing goods across continents.

Trailer theft is a growing problem, especially in areas of economic decline. Various locking mechanisms for trailer landing legs have been developed to address this problem. Several examples of landing leg locks include: https://equipmentlock.com/product/landing-gear-leg-lock/, https://www.raneystruckparts.com/the-jackdawg-trailer-landing-gear-lock/, https://www.transportsecurity.com/landing-gear-lock.html, U.S. Pat. Nos. 6,434,982, 6,494,476, 9,440,623, 10,017,019, 10,272,873, 10,414,384, 9,242,622, 9,393,936, US20070152437, and US20180194320. While advantageous in some respects, many of these lock designs can be easily circumvented, fail to provide any smart technology, are difficult to install and inconvenient to use, and are excessively bulky.

Others have tried using smart technology in trailer locks. US20220017040, for example, teaches a pad lock and a cover that can be unlocked via Bluetooth and RFID. This patent application also contemplates using GPS, motion sensors, and a wireless communication device. However, the locking mechanism is not compatible with semi-trailers or landing legs commonly used with fifth wheel type hitches. Moreover, the design is inconvenient because it requires unlocking both the cover and the lock, and the locking device must be stored in a safe place when the trailer is in use.

US20100036546 teaches remotely monitoring a trailer using a GPS tracker, and remotely locking/unlocking the landing leg via a wireless communication device. However, the design apparently only works for landing leg motors driven by compressed air.

Thus, there is still a need for improved landing leg locks.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods for a locking mechanism for a trailer landing leg having a crank shaft and a handle. The locking mechanism includes a bracket, a crank shaft attachment, and a locking pin assembly. The bracket is configured to couple with the landing leg via one or more one-time fasteners. The locking pin assembly is configured to couple with the bracket via one or more one-time fasteners. The crank shaft attachment is configured to couple with the crank shaft and the handle via one or more one-time fasteners. As used herein, “one-time fastener” means a permanent fastener that is not removable without destruction of the fastener and/or the locking mechanism.

The crank shaft attachment has (i) a through-hole sized and dimensioned to receive the crank shaft, (ii) a channel sized and dimensioned to receive the handle, and (iii) a radial recess that provides a clockwise stop and a counterclockwise stop for preventing rotations in either direction.

The locking pin assembly comprises a housing having a through-hole sized and dimensioned to receive the crank shaft, a locking pin disposed in the through-hole of the housing, and a motor functionally coupled with the locking pin. The motor preferably provides a torque of at least 500 kgf/cm. The motor moves the locking pin in a direction that is nonparallel to the crank shaft between a locked position and an unlocked position. The locking pin is in the locked position when it is disposed within the radial recess of the crank shaft attachment. The locking pin is in the unlocked position when it is not disposed within the radial recess of the crank shaft attachment. The locking pin is preferably made of a high strength material and is configured to withstand at least 15 metric tons of pressure. The locking pin can also have a diameter of at least 20 mm, although smaller diameters are also contemplated. In some embodiments, a rack and pinion are coupled with the motor and the locking pin to actuate movement of the locking pin. A spring can also be used to bias the locking pin towards the through-hole of the housing and towards the locked position.

In other aspects of some embodiments, the locking pin assembly can further comprise a processor programmed to actuate the motor, a rechargeable battery disposed in the housing and coupled with the processor, and an electrical connector coupled with the rechargeable battery and accessible from outside the housing for charging the rechargeable battery. In a preferred embodiment, the electrical connector is configured to couple with a vehicle battery for charging. The housing of the locking pin assembly is preferably waterproof. It is also contemplated that the individual components of the locking pin assembly can be waterproof.

In yet other aspects, the locking pin assembly can further comprise: a keypad coupled with the processor and configured to actuate the motor; an RFID reader coupled with the processor and configured to actuate the motor; a GPS tracker coupled with the processor and configured to track location; a temperature sensor coupled with the processor and configured to detect temperature; a motion sensor coupled with the processor and configured to detect motion; an audio transducer coupled with the processor and configured to detect sound and generate an audible alert; a light device coupled with the processor and configured to display a visual alert in response to a triggering event; and a wireless communication device coupled with the processor and configured to communicate with an external device.

In one embodiment, the motion sensor is a 3-axis accelerometer that detects motion of the locking pin assembly. In other another embodiment, the motion sensor is a magnet and a sensor that detects rotations of the crank shaft attachment. It is also contemplated that different types of motion sensors can be included in the locking mechanism to detect different types of motions and motions of different components. Various temperature sensors can be included in the locking mechanism to monitor and detect temperatures at different locations. Motion and temperature data can be used to determine an attempted theft. For example, if a threshold number of rotation and counter rotations are detected, this could indicate someone is attempting to break the locking mechanism and deploy the landing leg without authorization. If a threshold temperature is passed, this could indicate someone is attempting to break the locking mechanism (e.g., heat from a welding or cutting tool, cold from liquid nitrogen to cause cracking).

The processor can be programmed to display a visual alert, or an auditory alert based on data from one or more of the GPS tracker, the motion sensor, audio transducer, and the temperature sensor. For example, the processor can display an alert upon detecting a threshold number of rotations and counter-rotations of the crank shaft attachment, a threshold temperature, a threshold audible volume level or frequency signature, or a change in location.

The processor can also be programmed to notify an external device (e.g., vehicle driver, company headquarters, fleet management, law enforcement) via the wireless communication device when an attempted theft is in process or has occurred. Notifications can also include general updates on the location of the trailer and status of the locking mechanism (e.g., temperature, motion, location, locked/unlocked status). The wireless communication device preferably includes both a short-range antenna (e.g., Bluetooth) and a long-range antenna (e.g., cellular).

In other aspects of some embodiments, the processor is configured to auto-lock the locking mechanism upon detecting that the landing leg has been fully deployed or retracted. For example, the processor can move the locking pin to a locked position upon detecting a threshold number of rotations of the crank shaft attachment in the same direction. It is also contemplated that the processor can auto-lock the locking mechanism after a threshold duration of time following full deployment or retraction of the leg. In other aspects, the processor can auto-unlock the locking mechanism upon detecting close proximity with a trusted vehicle, a trusted external device (e.g., phone of a driver, tail light tracker), and/or a trusted location.

Various objects, features, aspects and advantages of the inventive subject matter will become more apparent from the following detailed description of preferred embodiments, along with the accompanying drawing figures, in which like numerals represent like components.

### BRIEF DESCRIPTION OF THE DRAWINGS

FIG. 1A is a front, left-side, perspective view of trailer landing leg.

FIG. 1B is a rear view of the landing leg of FIG. 1A.

FIG. 1C is a close-up, front, left-side perspective view of the landing leg of FIG. 1A.

FIG. 1D is a close-up, rear, left-side perspective view of the landing leg of FIG. 1A.

FIG. 1E is a left-side view of the landing leg of FIG. 1A.

FIG. 2A is a front view of the landing leg of FIG. 1A with a locking mechanism.

FIG. 2B is a front, left-side, perspective view of the landing leg and locking mechanism of FIG. 2A.

FIG. 2C is a left-side view of the landing leg and locking mechanism of FIG. 2A.

FIG. 2D is a rear view of the landing leg and locking mechanism of FIG. 2A.

FIG. 2E is a front, right-side, perspective view of the landing leg and locking mechanism of FIG. 2A.

FIG. 3A is a front, left-side, perspective view of the bracket of the locking mechanism of FIG. 2A.

FIG. 3B is a front view of the bracket of FIG. 3A.

FIG. 3C is a rear, right-side, perspective view of the bracket of FIG. 3A.

FIG. 4A is a front view of the crank shaft attachment of the locking mechanism of FIG. 2A.

FIG. 4B is a front, left-side, perspective view of the crank shaft attachment FIG. 4A.

FIG. 4C is a right-side view of the crank shaft attachment FIG. 4A.

FIG. 4D is a rear, left-side, perspective view of the crank shaft attachment FIG. 4A.

FIG. 5A is a front view of the locking pin assembly of the locking mechanism of FIG. 2A.

FIG. 5B is a rear view of the locking pin assembly of FIG. 5A.

FIG. 5C is a front, right-side, perspective view of the locking pin assembly of FIG. 5A.

FIG. 5D is a front, left-side, perspective view of the locking pin assembly of FIG. 5A in a locked position.

FIG. 5E is a front, left-side, perspective view of the locking pin assembly of FIG. 5A in an unlocked position.

FIG. 6A is a front, left-side, perspective view of the landing leg of FIG. 1A with the bracket of FIG. 3A.

FIG. 6B is a front, left-side, perspective view of the landing leg of FIG. 1A with the bracket of FIG. 3A and the crank shaft attachment of FIG. 4A.

FIG. 6C is a front, left-side, perspective view of the landing leg of FIG. 1A with the bracket of FIG. 3A, the crank shaft attachment of FIG. 4A, and the locking pin assembly of FIG. 5A.

FIG. 6D is a front, right-side, perspective view of the landing leg of FIG. 1A with the bracket of FIG. 3A, the crank shaft attachment of FIG. 4A, the locking pin assembly of FIG. 5A, and a handle.

FIG. 6E is a front, left-side, perspective view of the landing leg of FIG. 1A with the bracket of FIG. 3A, the crank shaft attachment of FIG. 4A, and the locking pin assembly of FIG. 5A with the housing removed.

FIG. 7A is a front, left-side, perspective view of the locking pin assembly of FIG. 5A with the housing removed and the locking pin in the locked position.

FIG. 7B is a front, left-side, perspective view of the locking pin assembly of FIG. 5A with the housing removed and the locking pin in the unlocked position.

FIG. 7C is a rear, right-side, perspective view of the locking pin assembly of FIG. 5A with the rear cover removed.

### DETAILED DESCRIPTION OF THE INVENTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

It should be noted that any language directed to processors and computers should be read to include any suitable combination of computing devices, including servers, interfaces, systems, databases, agents, peers, engines, controllers, actuators, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided herein is prior art or relevant to the presently claimed invention, or that any publication specifically or implicitly referenced is prior art.

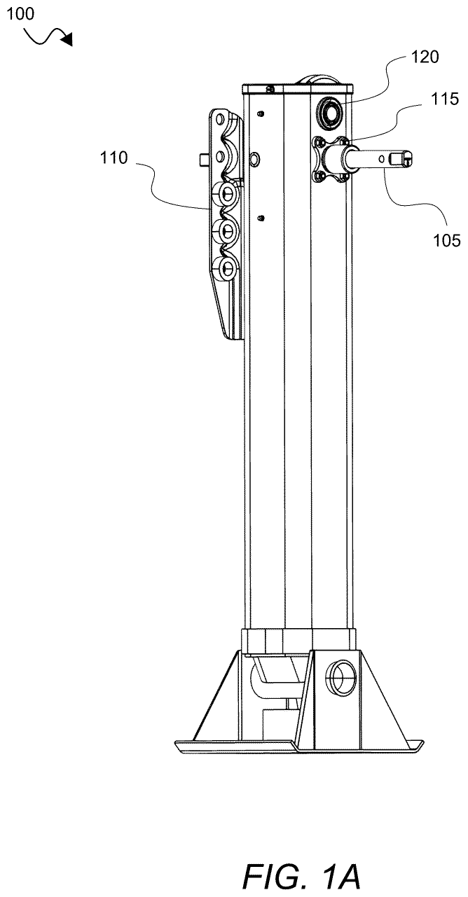

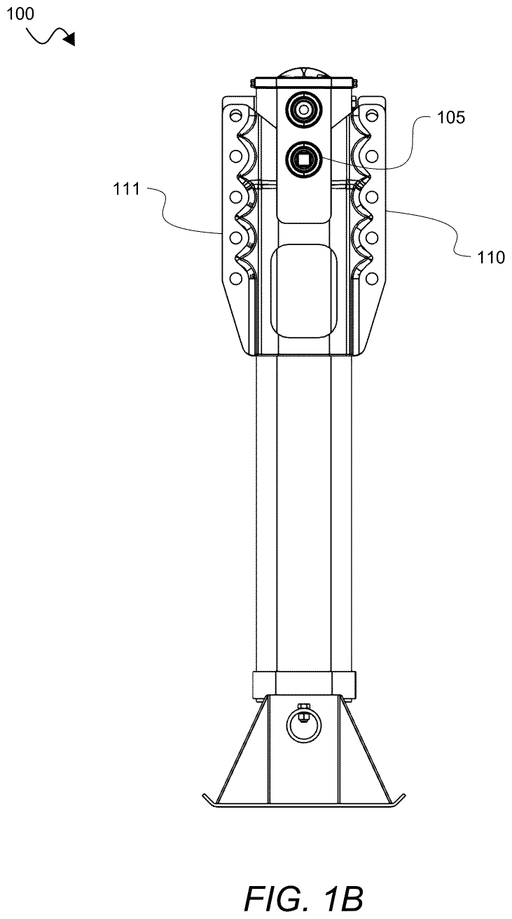

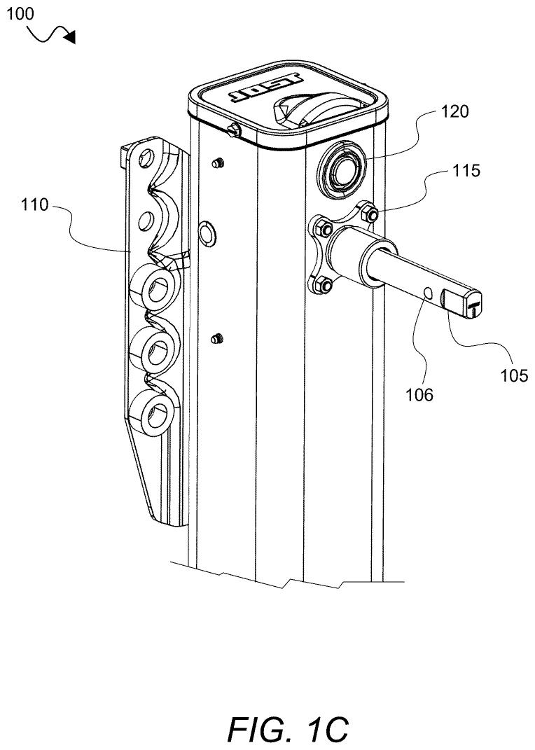

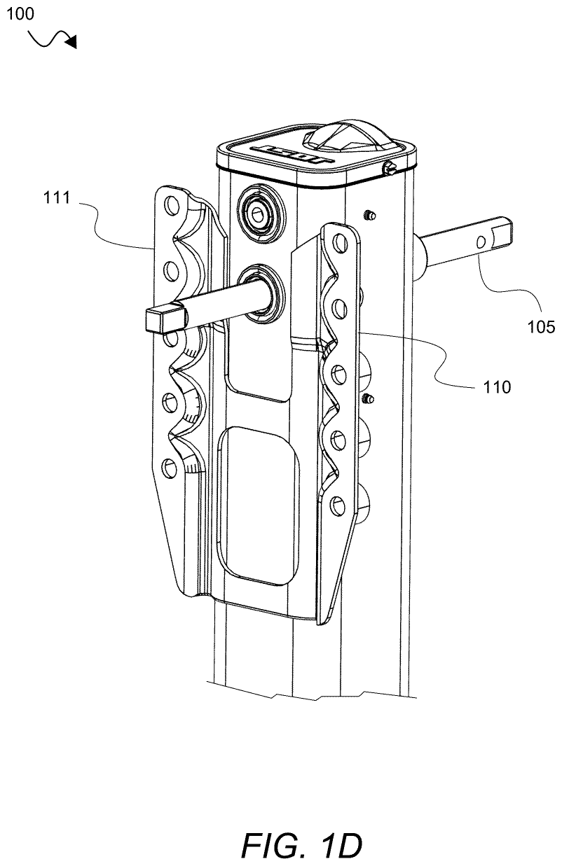

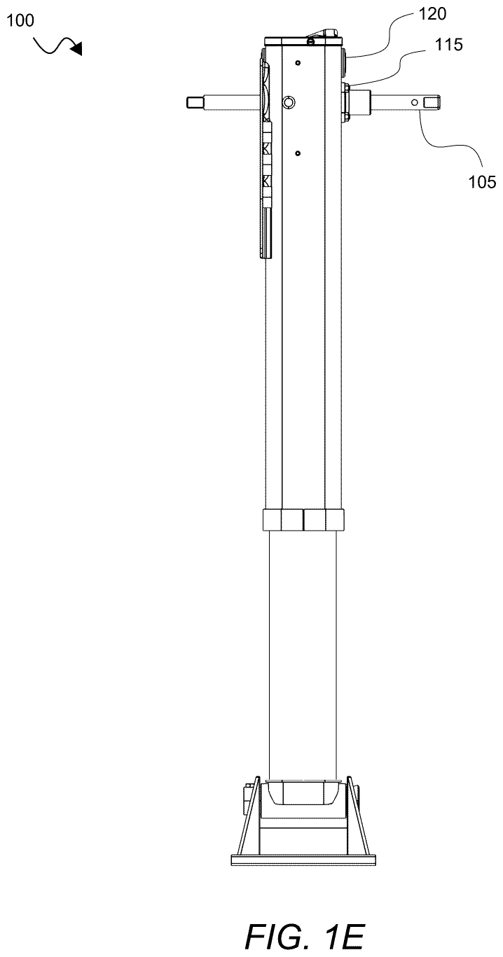

FIG. 1A is a front, left-side, perspective view of a semi-trailer landing leg 100. Landing leg 100 has a crank shaft 105 that can be rotated to deploy (e.g., lower) and retract (e.g., raise) a portion of landing leg 100. Landing leg 100 also has a left flange 110 and a right flange 111 with a plurality of holes for attaching landing leg 100 to a trailer. FIG. 1B is a rear view of landing leg 100. FIG. 1C is a close-up, front, left-side perspective view of landing leg 100. Crank shaft 105 has a hole 106 for attaching a handle 180. FIG. 1D is a close-up, rear, left-side perspective view of landing leg 100. FIG. 1E is a left-side view of landing leg 100.

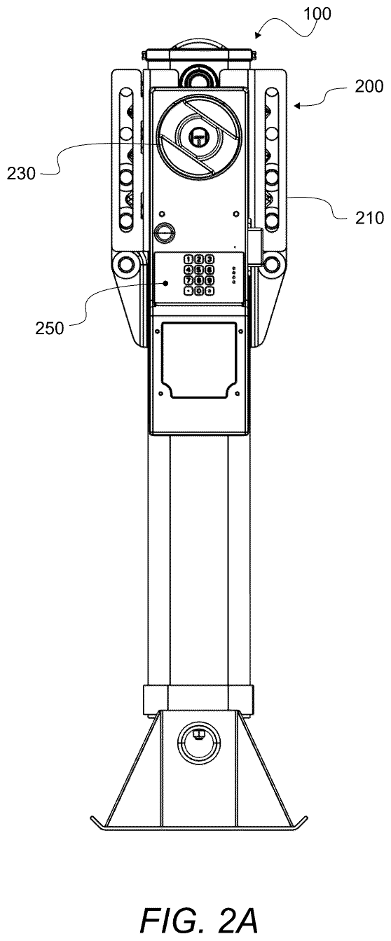

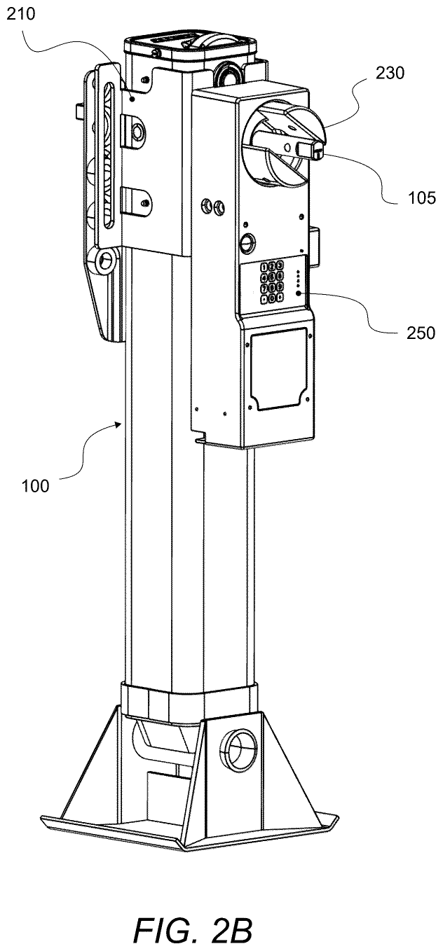

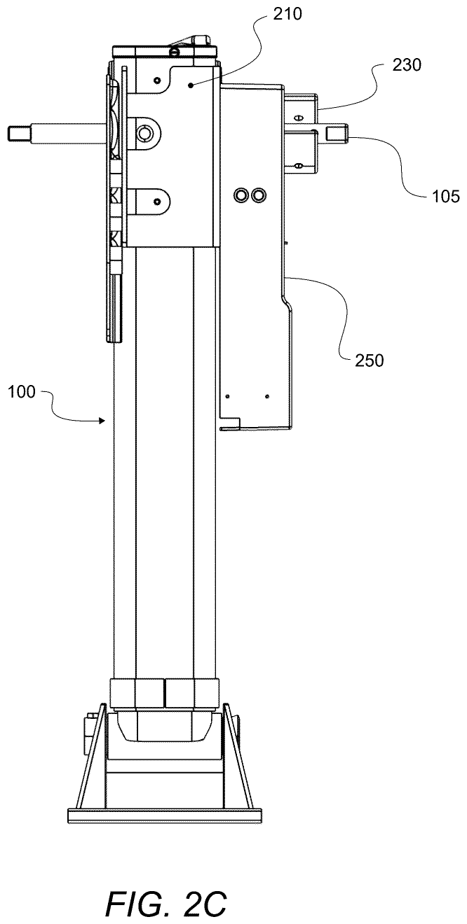

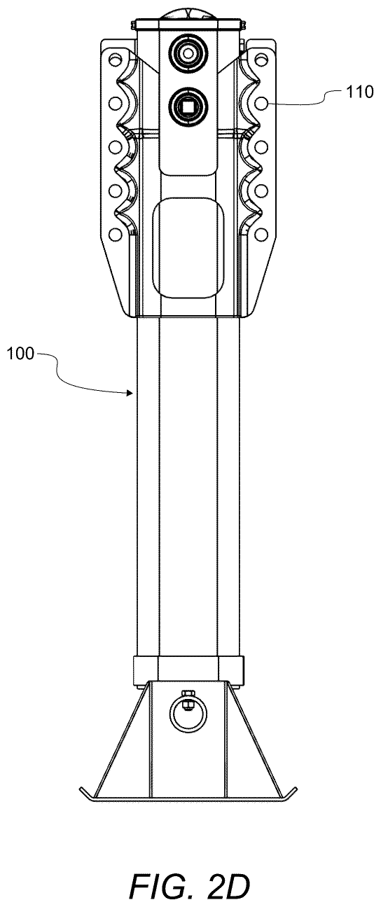

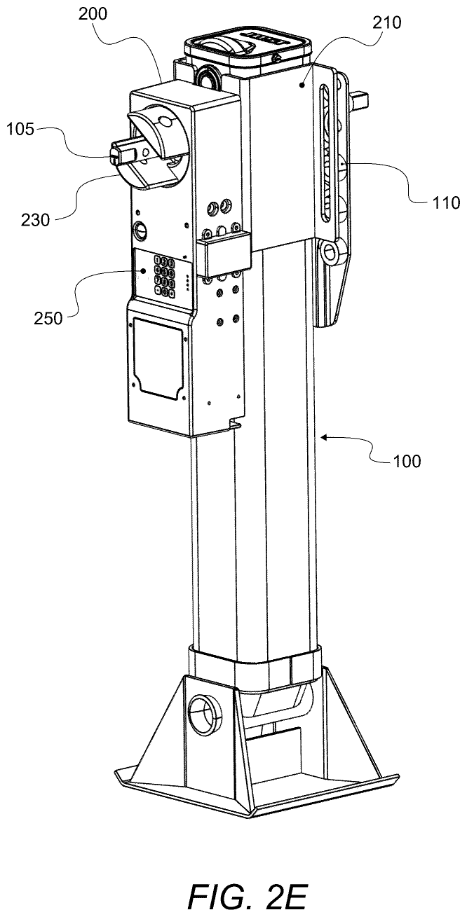

FIG. 2A is a front view of landing leg 100 with a locking mechanism 200. FIG. 2B is a front, left-side, perspective view of landing leg 100 and locking mechanism 200. FIG. 2C is a left-side view of landing leg 100 and locking mechanism 200. FIG. 2D is a rear view of landing leg 100 and locking mechanism 200. FIG. 2E is a front, right-side, perspective view of landing leg 100 and locking mechanism 200.

Locking mechanism 200 is comprised of a bracket 210, a crank shaft attachment 230, and a locking pin assembly 250.

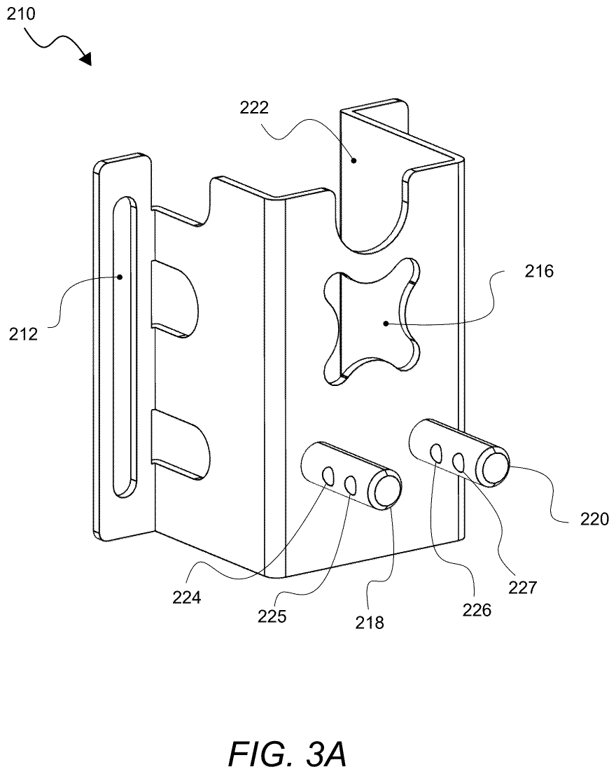

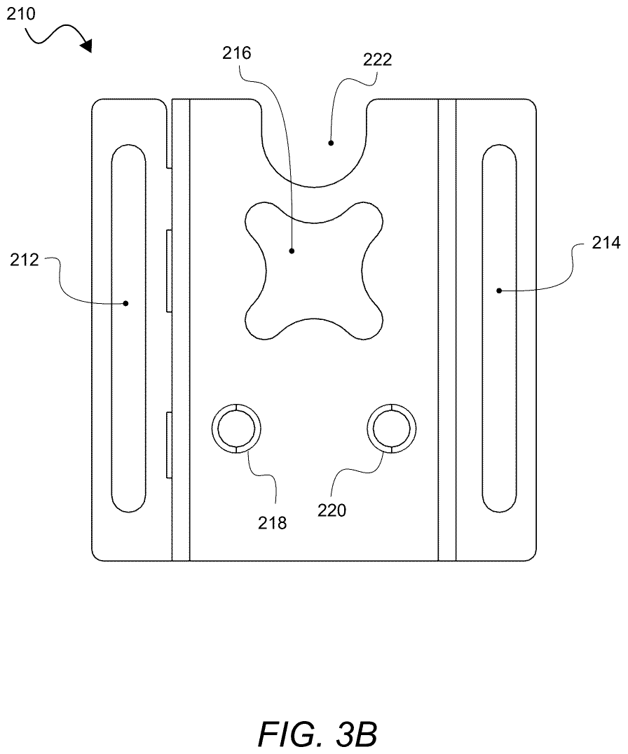

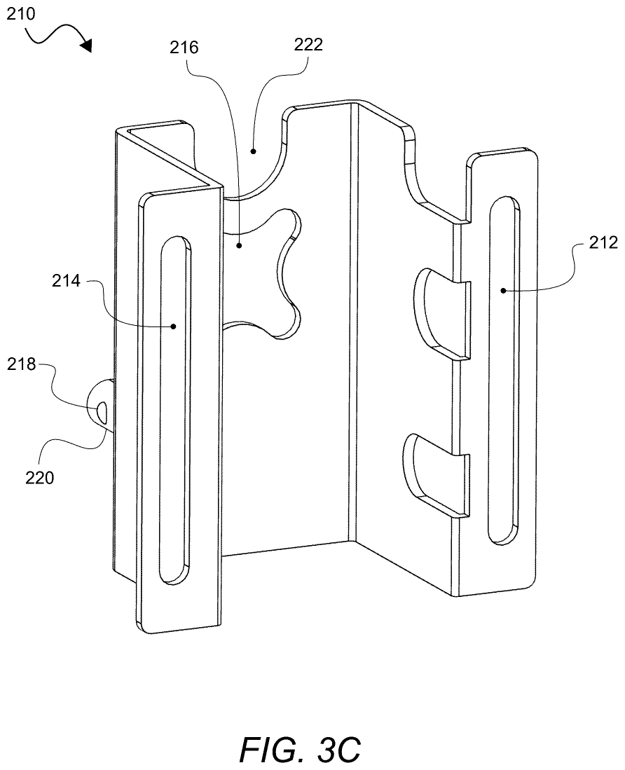

FIG. 3A is a front, left-side, perspective view of bracket 210. FIG. 3B is a front view of bracket 210. FIG. 3C is a rear, right-side, perspective view of bracket 210. Bracket 210 is sized and dimensioned to attach to landing leg 100. Bracket 210 has a left-side flange with an opening 212 and a right-side flange with an opening 214. The flanges of bracket 210 align with flanges 110, 111 of landing leg 100 such that openings 212, 214 of bracket 210 align with the holes on flanges 110, 111 of landing leg 100. A plurality of one-time fasteners can be used with openings 212, 214 and the holes of flanges 110, 111 to attach bracket 210 to landing leg 100 on a trailer.

Bracket 210 has an opening 216 sized and dimensioned to receive crank shaft 105 and protrusion 115 (e.g., bracket) on landing leg 100. Bracket 210 has an opening 222 sized and dimensioned to fit around circular protrusion 120 on landing leg 100. Bracket 210 is configured to fit snugly on landing leg 100 and surround crank shaft 105. Bracket 210 con

Bracket 210 has a left protrusion 218 with side holes 224, 225 and a right protrusion 220 with side holes 226, 227. Protrusions 218, 220 are for attaching locking pin assembly 250.

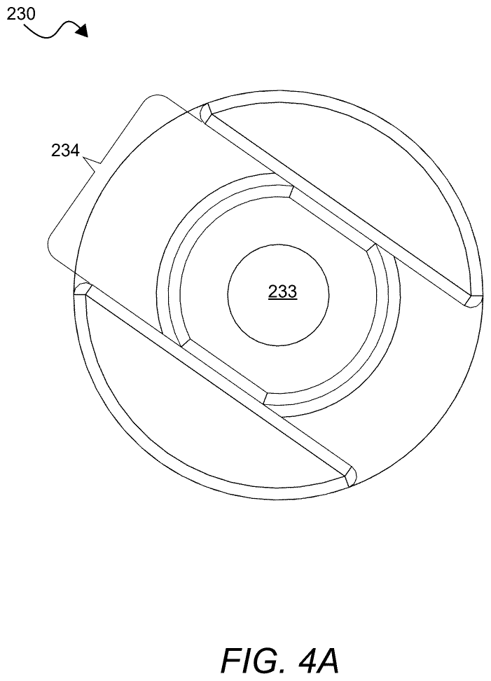

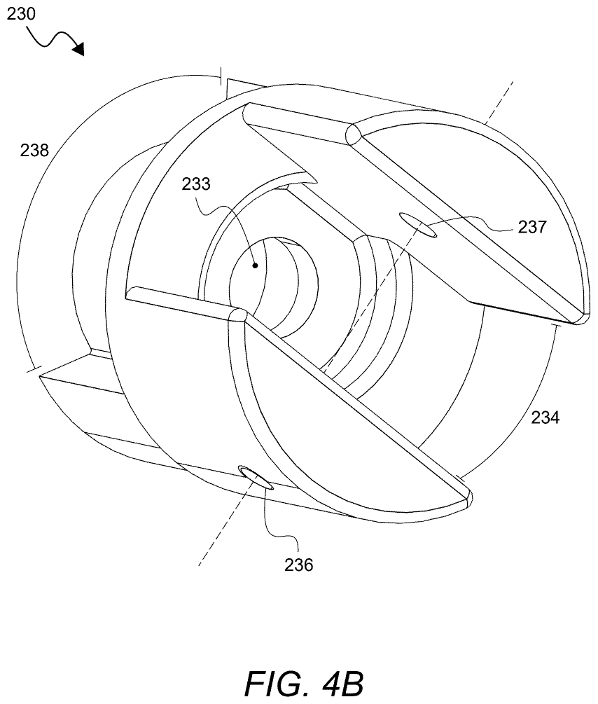

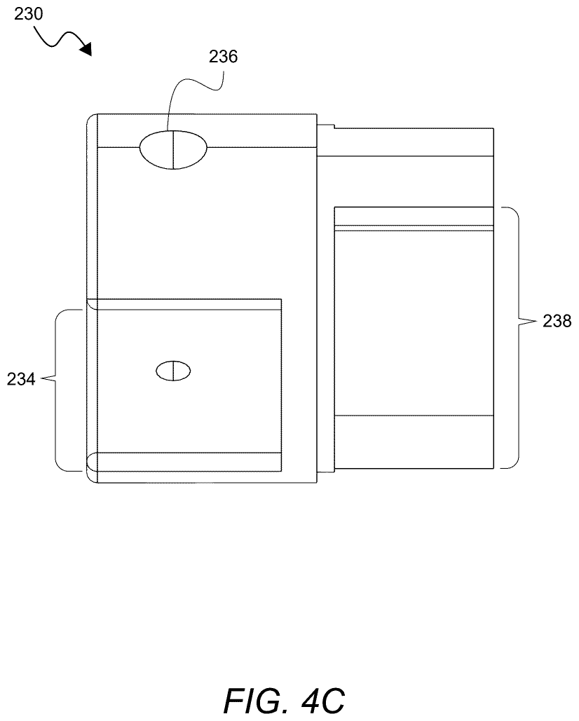

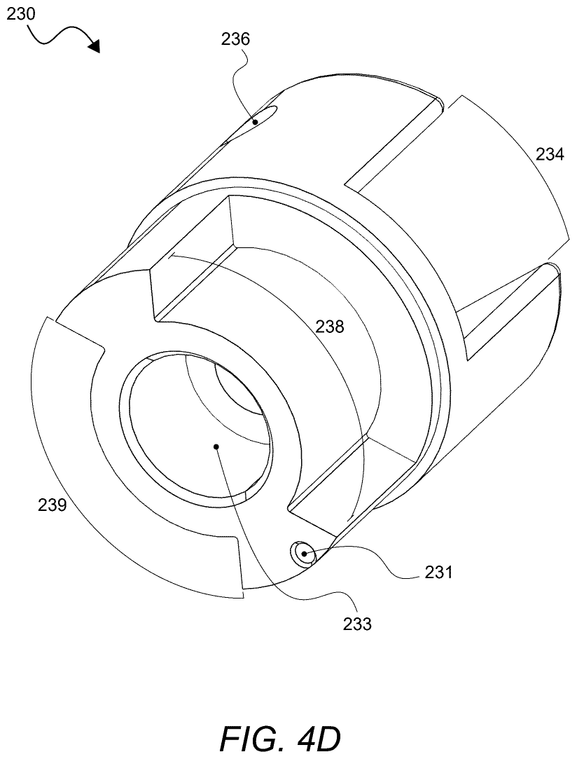

FIG. 4A is a front view of crank shaft attachment 230. FIG. 4B is a front, left-side, perspective view of crank shaft attachment 230. FIG. 4C is a right-side view of crank shaft attachment 230. FIG. 4D is a rear, left-side, perspective view of crank shaft attachment 230. Crank shaft attachment 230 has a center hole 233 sized and dimensioned to receive crank shaft 105. The front surface of crank shaft attachment 230 has a channel 234 that is sized and dimensioned to snugly fit with the end of handle 180. Channel 234 has a hole 236 and a hole 237 that align with hole 106 on crank shaft 105 and holes on the end of handle 180. A one-time fastener can be inserted through holes 236, 237, 106, and the holes on handle 180 to attach crank shaft 105, crank shaft attachment 230, and handle 180 together. In this manner, handle 180 and crank shaft 105 cannot be rotated without also rotating crank shaft attachment 230.

The rear side of crank shaft attachment 230 has a first radial recess 238 and a second radial recess 239 that interact with locking pin 254 of locking pin assembly 250 to stop crank shaft attachment 230 from rotating. The radial dimensions of first radial recess 238 and second radial recess 239 determine the degrees of rotation that crank shaft attachment 230 can turn when locking pin 254 is in the locked position. First radial recess 238 and second radial recess 239 are between 90 and 180 degrees. However, it is contemplated that the degrees could be between 0 and 360, and that there could be only one radial recess, or more than two radial recesses.

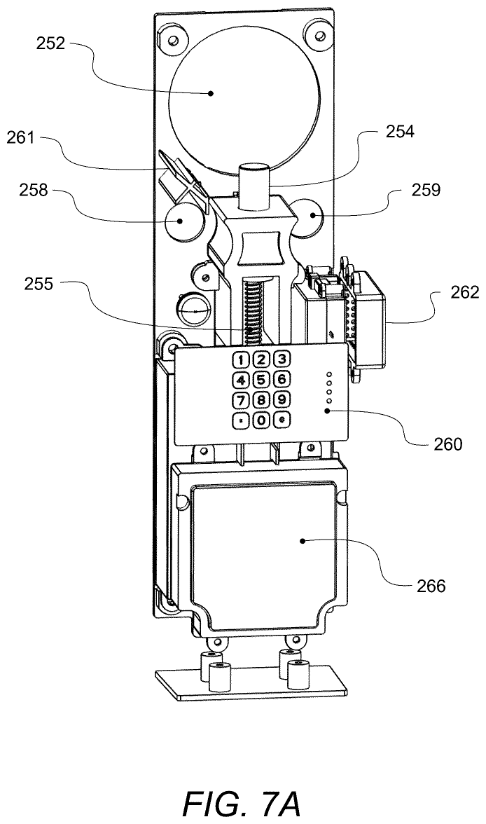

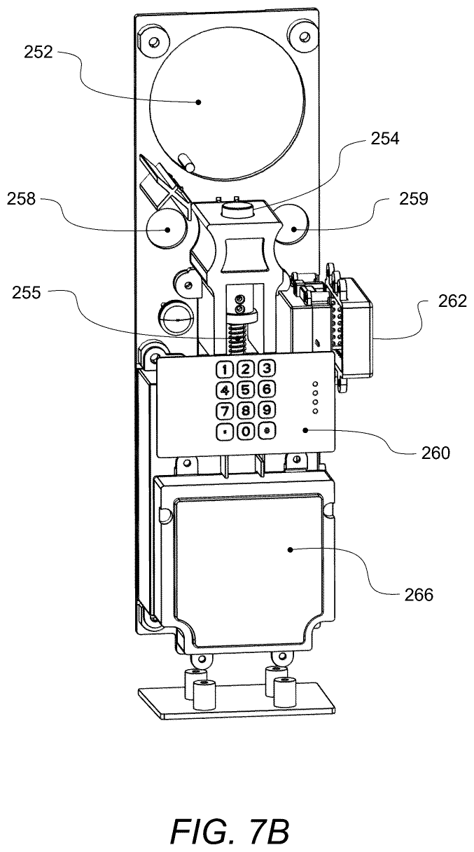

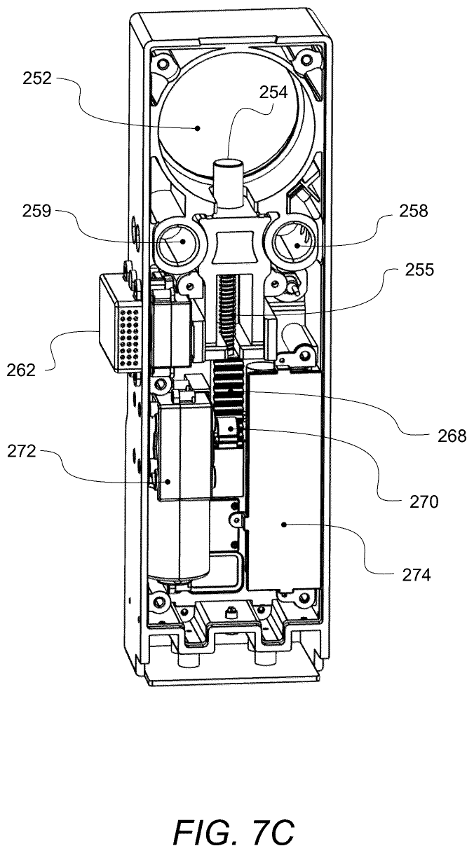

The rear surface of crank shaft attachment 230 has a magnet 231 that rotates near sensor 261 of locking pin assembly 250 (see FIG. 7A). Sensor 261 is configured to count the number of rotations of crank shaft attachment 230. It is contemplated that crank shaft attachment 230 can have additional magnets for more precise monitoring of the rotations of crank shaft attachment 230.

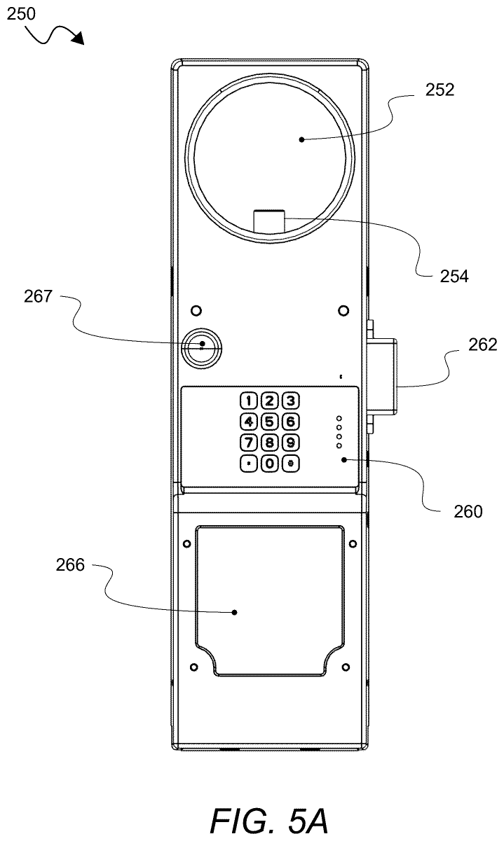

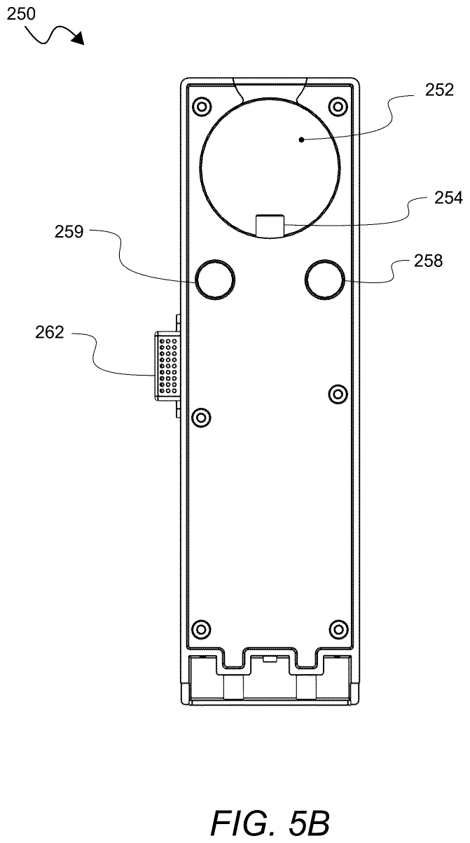

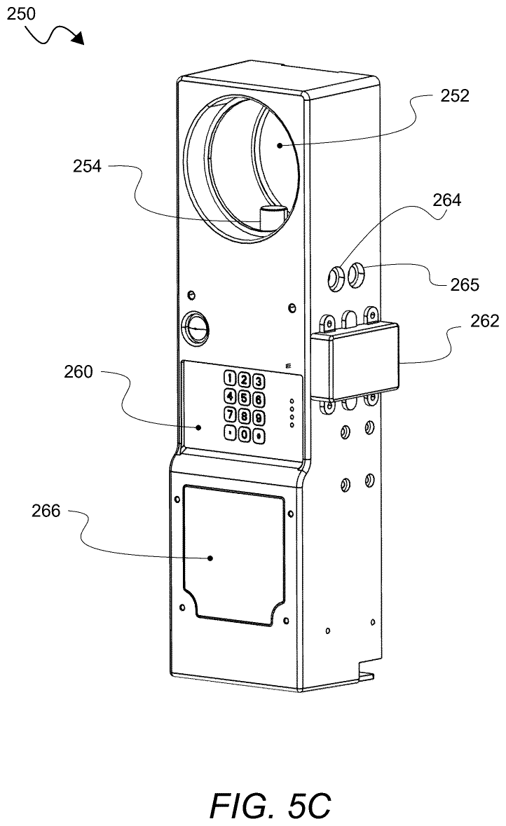

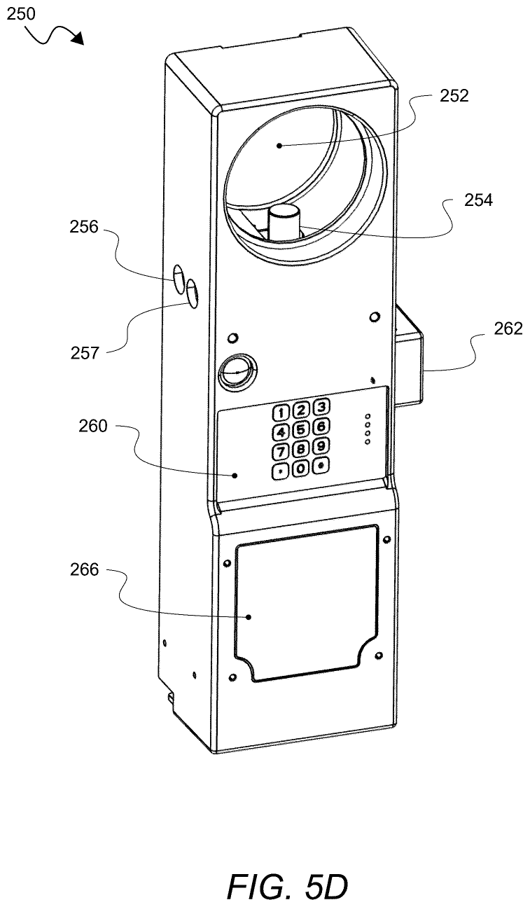

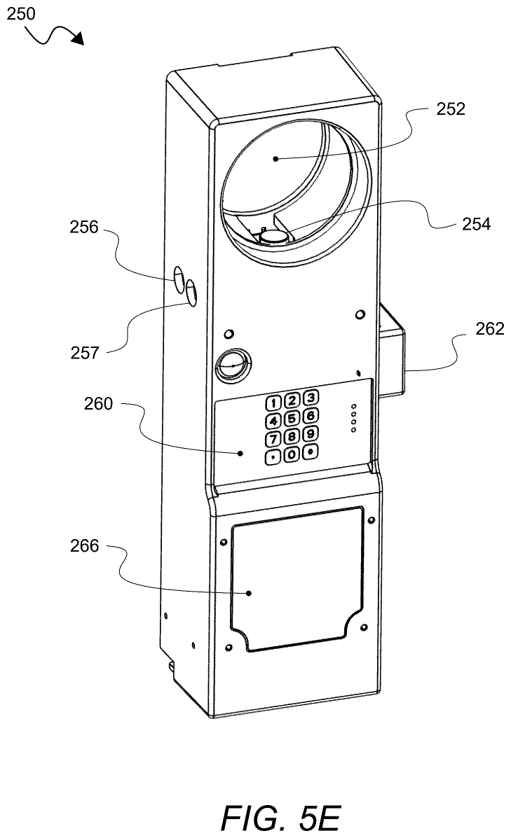

FIG. 5A is a front view of locking pin assembly 250. FIG. 5B is a rear view of locking pin assembly 250. FIG. 5C is a front, right-side, perspective view of locking pin assembly 250. Locking pin assembly 250 has an opening 252 sized and dimensioned to receive crank shaft attachment 230. Locking pin assembly 250 has a locking pin 254 in opening 252 that moves between a locked position and an unlocked position. Locking pin assembly 250 has a light 267 and a speaker 262 (e.g., audio transducer) for communicating alerts and notifications to a user.

FIG. 5D is a front, left-side, perspective view of locking pin assembly 250 in a locked position. FIG. 5E is a front, left-side, perspective view of locking pin assembly 250 in an unlocked position. Locking pin 254 moves in a direction that is nonparallel to the longitudinal axis (e.g., length) of crank shaft 105. In the present embodiment, locking pin 254 moves in an up and down direction. More importantly, locking pin 254 moves into and out of the rotational path of first radial recess 238 and second radial recess 239. Crank shaft attachment 230 and locking pin 254 are preferably sized and dimensioned, and made of sufficiently strong materials, such that they can withstand at least 15 metric tons of pressure. In some embodiments, locking pin 254 can have a diameter or width of at least 20 mm.

Locking pin assembly 250 has a keypad 260 and an RFID reader 266 for locking and unlocking pin 254. Keypad 260 has one or more lights for indicating connectivity of the wireless communication devices. The rear side of locking pin assembly 250 has an opening 258 and an opening 259 that are sized and dimensioned to mate with protrusions 218 and protrusion 220, respectively, on bracket 210. Once locking pin assembly 250 is mounted on bracket 210, openings 256, 257 on the left side of locking pin assembly 250 align with holes 224, 225 on protrusion 218 of bracket 210, respectively. Likewise, openings 264, 265 on the right side of locking pin assembly 250 align with holes 227, 226 on protrusion 220 of bracket 210. One-time fasteners can be inserted into openings 256, 257, 264, 265 and through holes 224, 225, 227, 226 to attach locking pin assembly 250 to bracket 210.

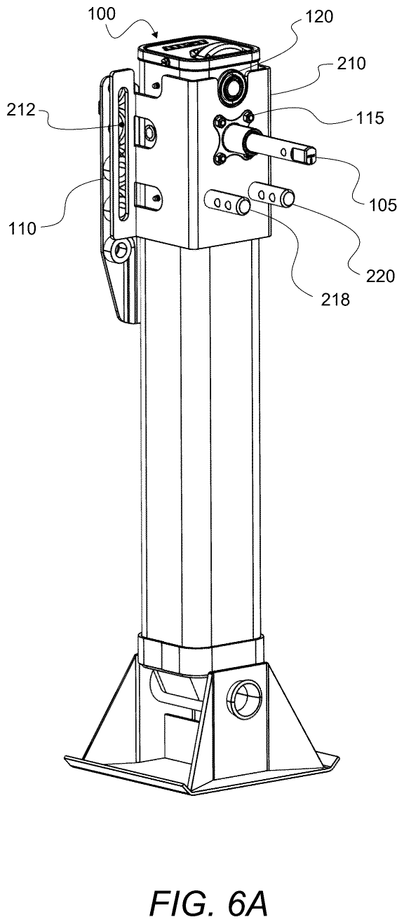

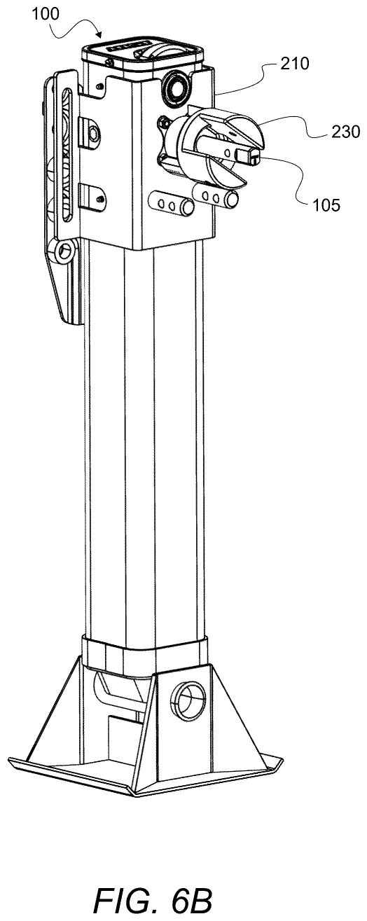

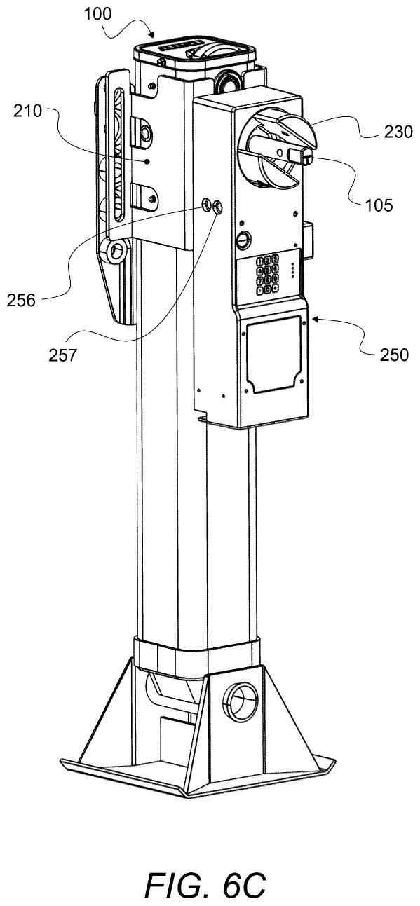

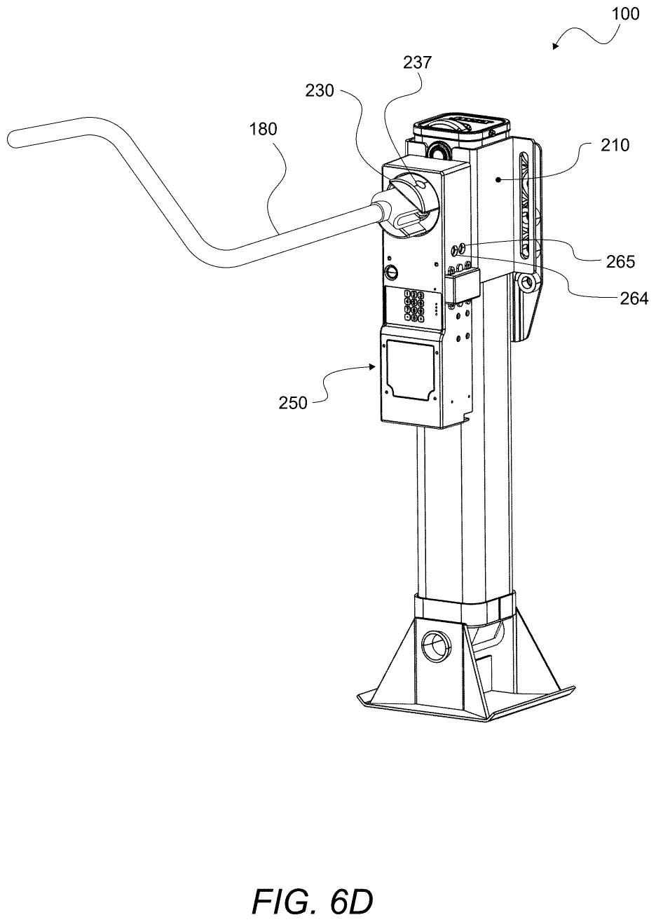

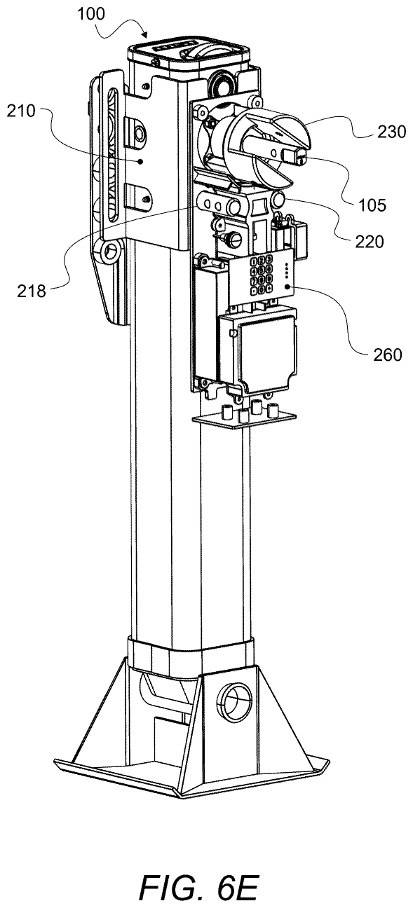

FIGS. 6A-6D demonstrate a method of installing locking mechanism 200 on landing leg 100. In FIG. 6A, bracket 210 is placed on landing leg 100 with crank shaft 105 passing through opening 216, and with opening 222 around protrusion 120. Openings 212, 214 are aligned with the holes of flanges 110, 111 for inserting a one-time fastener. In FIG. 6B, crank shaft attachment 230 is placed over crank shaft 105 and holes 236, 237 are aligned with hole 106. In FIG. 6C, locking pin assembly 250 is placed on bracket 210 by inserting protrusions 218, 220 into openings 258, 259 and by inserting crank shaft attachment 230 through opening 252. One-time fasteners are then placed in openings 256, 257, 264, 265. In FIG. 6D, handle 180 is placed on crank shaft 105 with the holes of handle 180 aligned with hole 106 and holes 236, 237 for inserting a one-time fastener.

FIG. 6E is a front, left-side, perspective view of landing leg 100 and locking mechanism 200, with the housing of locking pin assembly 250 removed to better show how bracket 210, crank shaft attachment 230, and locking pin assembly 250 are attached. The housing of locking pin assembly 250 is preferably waterproof. It is also contemplated that the individual components inside the housing can also be waterproofed.

FIG. 7A is a front, left-side, perspective view of locking pin assembly 250 with the housing removed and locking pin 254 in the locked position. FIG. 7B is a front, left-side, perspective view of locking pin assembly 250 with the housing removed and locking pin 254 in the unlocked position. FIG. 7C is a rear, right-side, perspective view of locking pin assembly 250 with the rear cover removed and locking pin 254 in the locked position.

Locking pin assembly 250 has a rack 268 and pinion 270 coupled with a motor 272. Rack 268 and pinion 270 are also coupled with a spring 255 and locking pin 254. Spring 255 biases locking pin 254 towards opening 252 and towards the locked position. Motor 272 rotates pinion 270 to actuate the movement of locking pin 254 between the locked and unlocked position.

Locking pin assembly 250 has a rechargeable battery 274 that provides power to a circuit board (e.g., PCBA) located behind RFID reader 266. Battery 274 can be charged by connecting a cable (not shown) to a power supply, such as a vehicle battery. The circuit board is connected with motor 272, keypad 260, and RFID reader 266 for controlling the position of locking pin 254. The circuit board is also connected with sensor 261 for detecting rotations of magnet 231 on crank shaft attachment 230. The circuit board is also connected with one or more motion sensors (e.g., 3 axis accelerometer), one or more audio transducers, one or more video cameras, and one or more temperature sensors for detecting attempts to tamper with locking mechanism 200. The circuit board is also connected with a GPS tracker (e.g., satellite antenna) for determining and monitoring the location of locking mechanism 200. The circuit board can comprise a microcontroller and a processor with executable software instructions for operating locking mechanism 200 and for providing various functions and auto features.

The circuit board is also connected with a short-range wireless communication device (e.g., Bluetooth antenna) and a long-range wireless communication device (e.g., cellular antenna) for communicating with an external device. The wireless communication devices can be used to send location information to an external device, such as a vehicle driver, a remote monitoring center, a shipping destination, an owner of the cargo, an owner of the trailer, company headquarters, a fleet manager, or law enforcement. The wireless communication devices can also be used to communicate motion data, temperature data, locked/unlocked status, tamper alerts, audio/video data, and any other information collected by locking mechanism 200 to an external device.

Light 267 and speaker 262 can be used to communicate information to a user who is physically located at locking mechanism 200. For example, light 267 can be configured to display a visual alert and speaker 262 can be configured to display an audio alert indicating a failed attempt to lock or unlock the device. Light 267 and speaker 262 can also be configured to alert a user upon detecting tampering. The circuit board and the processor can be configured to detect tampering using any of the sensor data available. For example, when locking mechanism 200 is in the locked position and sensor 261 detects a threshold number of rotation and counter rotations of magnet 231, the processor can display an alert (e.g., alarm) via light 267 and speaker 262 to indicate that tampering is detected. A notification regarding the detected tampering can also be sent to an external device and/or remote device via the wireless communication devices. The wireless communication devices of locking mechanism 200 can also be used to receive a lock and/or unlock command from an external device and/or remote device.

It is also contemplated that data from the GPS tracker can trigger an alert, such as when the trailer has entered an unauthorized location or has stopped for an unauthorized amount of time. The GPS tracker can also be used to auto-unlock locking mechanism 200 when the GPS tracker is within a trusted area and auto-lock locking mechanism 200 when the GPS tracker is outside a trusted area.

The GPS tracker and processor can also be configured to auto-unlock locking mechanism 200 when a trusted external device is within close proximity. For example, the external device could be a tail light tracker as disclosed in applicant's prior international patent publication, WO2023059741, which is incorporated herein by reference. WO2023059741 teaches a tail light tracker with a hidden GPS tracker and a wireless communication device. Locking mechanism 200 can be used in combination with one or more tail light trackers to provide auto-lock and auto-unlock features. When a tail light tracker is installed on a trusted vehicle (e.g., a company truck), locking mechanism 200 could be programmed to auto-unlock upon detecting that the trusted truck is attached to the trailer, or upon detecting that the truck is in close proximity to the locking mechanism 200. Locking mechanism 200 preferably communicates directly with the tail light tracker via either a shortrange wireless communication protocol (e.g., Bluetooth) or a long range wireless communication protocol (e.g., cellular transmission, WiFi). It is also contemplated that locking mechanism 200 indirectly communicates with the tail light tracker via a remote monitoring center that is located remotely from the trailer.

Locking mechanism 200 can also communicate with multiple tail light trackers. For example, a first tail light tracker can be located on the trailer and a second tail light tracker can be located on the truck. Tampering with either trail light tracker could cause locking mechanism 200 to auto-lock and send a tamper distress signal to a remote monitoring center. It is also contemplated that tampering with locking mechanism 200 could cause the tail light trackers to flash. Tampering with locking mechanism 200 could also cause a camera hidden within the tail light tracker to record and store audio and video data, and to transmit audio and video data to the remote monitoring center.

Locking mechanism 200 and external trusted devices such as the tail light trackers preferably communicate directly a remote monitoring center independently of one another such that the system has redundant communication links. If the cellular transmission capability of one device fails due to tampering, but the short-range communication remains functional, the device could communicate with the remote monitoring center via another device. Data from each device can also be gathered, compiled, and corroborated by the remote monitoring center to further improve tamper detection algorithms. When the remote monitoring center is communicating with multiple devices for one trailer, one of the devices can be designated as the primary device. The primary device can send GPS location information and comprehensive data reports to the remote monitoring center while the secondary devices might only send a subset of data to the remote monitoring center. For example, secondary devices could be programmed to send GPS location data to the remote monitoring center on a less frequent basis to conserve battery life and to prevent duplication of data storage by the remote monitoring center. Secondary devices may send frequent pings to the remote monitoring center to communicate that the device is online and working, without sending full data reports at every ping. When a primary device is tampered or compromised, remote monitoring center can designate a secondary device as the new primary device.

It is also contemplated that tampering can also be detected using temperature and motion data from locking mechanism 200 and/or other external trusted devices. For example, if a threshold maximum temperature is passed, this could indicate tampering from a welding or cutting tool, and if a threshold minimum temperature is passed, this could indicate tampering from liquid nitrogen to cause cracking. If a threshold vibrational frequency or a threshold impact force is detected, this could indicate tampering from a cutting tool or a breaking tool. As another example, if motion is detected on locking mechanism 200 but motion is not detected on a tail light tracker on the trailer, this could also indicate tampering. Locking mechanism 200 and/or a remote monitoring center preferably gathers all available data to improve accuracy of tamper detection.

The inventive subject matter described herein provides a locking mechanism for a trailer landing leg that is easy to install, convenient to use, and very secure from theft and tampering. The locking mechanisms described herein are also compatible with conventional semi-trailer landing legs without modifying the landing gear. The inventive subject matter also describes a locking mechanism that can be controlled and monitored remotely via wireless communication, and includes tamper detection, alerts, and auto-lock features.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A locking mechanism for a trailer landing leg having a crank shaft and a handle, comprising:
a bracket configured to couple with the landing leg;
a crank shaft attachment having (i) a through-hole sized and dimensioned to receive the crank shaft, (ii) a channel sized and dimensioned to receive the handle, and (iii) a radial recess;
a locking pin assembly comprising:
a housing having a through-hole sized and dimensioned to receive the crank shaft and crank shaft attachment;
a locking pin disposed in the through-hole of the housing;
a motor functionally coupled with the locking pin and configured to move the locking pin in a direction that is nonparallel to the crank shaft; and
wherein the locking pin assembly is configured to couple with the bracket.

2. The locking mechanism of claim 1, wherein the locking pin assembly further comprises:
a rack and pinion coupled with the motor; and
a spring coupled with the rack and pinion and disposed to bias the locking pin towards the through-hole of the housing.

3. The locking mechanism of claim 1, further comprising one or more one-time fasteners for coupling the bracket with the landing leg.

4. The locking mechanism of claim 1, further comprising one or more one-time fasteners for coupling the locking pin assembly with the bracket.

5. The locking mechanism of claim 1, further comprising one or more one-time fasteners for coupling the handle, crank shaft, and crank shaft attachment together.

6. The locking mechanism of claim 1, wherein the locking pin assembly further comprises;
a rechargeable battery disposed in the housing;
an electrical connector coupled with the rechargeable battery and accessible from outside the housing for charging the rechargeable battery; and
a processor programmed to actuate the motor.

7. The locking mechanism of claim 6, wherein the electrical connector couples with a vehicle battery for charging.

8. The locking mechanism of claim 6, wherein the locking pin assembly further comprises;
a keypad coupled with the processor and configured to actuate the motor;
an RFID reader coupled with the processor and configured to actuate the motor;
a GPS tracker coupled with the processor and configured to track location;
a temperature sensor coupled with the processor and configured to detect temperature;
a motion sensor coupled with the processor and configured to detect motion;
an audio transducer coupled with the processor and configured to generate a visual alert;
a light device coupled with the processor and configured to display a light in response to a triggering event; and
a wireless communication device coupled with the processor and configured to communicate with an external device.

9. The locking mechanism of claim 8, wherein the motion sensor is a 3-axis accelerometer.

10. The locking mechanism of claim 8, wherein the motion sensor is a magnet and a sensor that detects rotations of the crank shaft attachment.

11. The locking mechanism of claim 10, wherein the processor is configured to display a visual alert or an auditory alert upon detecting a threshold number of rotations and counter-rotations of the crank shaft attachment.

12. The locking mechanism of claim 10, wherein the processor is configured to move the locking pin to a locked position upon detecting a threshold number of rotations of the crank shaft attachment.

13. The locking mechanism of claim 10, wherein the processor is configured to move the locking pin to a locked position after a threshold duration of time upon detecting a threshold number of rotations of the crank shaft attachment.

14. The locking mechanism of claim 8, wherein the processor is configured to display a visual alert, or an auditory alert based on data from one or more of the GPS tracker, the motion sensor, and the temperature sensor.

15. The locking mechanism of claim 8, wherein the processor is configured to notify an external device via the wireless communication device based on data from one or more of the GPS tracker, the motion sensor, and the temperature sensor.

16. The locking mechanism of claim 8, wherein the wireless communication device comprises a short-range antenna and a long-range antenna.

17. The locking mechanism of claim 6, wherein the processor is configured to move the locking pin to an unlocked position upon detecting close proximity with a trusted vehicle or a trusted external device.

18. The locking mechanism of claim 1, wherein the motor provides a torque of at least 500 kgf/cm.

19. The locking mechanism of claim 1, wherein the locking pin is made of a high strength material, is configured to withstand at least 15 metric tons of pressure, and has a diameter of at least 20 mm.

20. The locking mechanism of claim 1, wherein the housing of the locking pin assembly is waterproof.
